(19) United States
(12) Patent Application Publication
(10) Pub. No.: US 2024/0234756 A9
(43) Pub. Date: Jul. 11, 2024

(54) VEHICLE FRONT STRUCTURE

(71) Applicant: TOYOTA JIDOSHA KABUSHIKI KAISHA, Toyota-shi Aichi-ken (JP)

(72) Inventor: Yu HOSHINO, Toyota-shi Aichi-ken (JP)

(21) Appl. No.: 18/374,710

(22) Filed: Sep. 29, 2023

(30) Foreign Application Priority Data
Oct. 20, 2022 (JP) 2022-168569

(51) Int. Cl. H01M 8/04029; B60H 1/00; B60R 5/02; F24H 1/00

(52) U.S. Cl. CPC H01M 8/04029; B60H 1/00385; B60R 5/02; F24H 1/009

(57) ABSTRACT

A front structure of a fuel cell vehicle is provided, which can suppress blowing wind from hitting a water heater located in a front compartment. A fuel cell vehicle is equipped with a water heater that heats water to warm air for air-conditioning in a front compartment that is separated from a vehicle cabin by a dash panel. A front trunk is provided within the front compartment. The front trunk is divided from other spaces by wall portions. The water heater is located behind the rear wall portion of the front trunk.

### CROSS-REFERENCE TO RELATED APPLICATION

This application claims priority to Japanese Patent Application No. 2022-168569 filed on Oct. 20, 2022, the entire contents of which are herein incorporated by reference.

### TECHNICAL FIELD

The present disclosure relates to a vehicle front structure of a fuel cell vehicle equipped with a water heater in a front compartment that is separated from a vehicle compartment by a dash panel.

### BACKGROUND ART

In a fuel cell vehicle (FCEV: Fuel Cell Electric Vehicle) that runs on electricity generated by a fuel cell stack, cooling water heated by waste heat from the fuel cell stack is supplied to a heater core. By doing so, the waste heat from the fuel cell stack is often used for heating. In such cases where the waste heat from the fuel cell stack is used for heating, a water heater is generally used to heat the cooling water when the temperature of the cooling water supplied to the heater core is lower than a target water temperature at an inlet of the heater core.

In many cases, such a water heater is located in the front compartment of the fuel cell vehicle, which corresponds to an engine compartment in an engine vehicle. Various proposals have been made in the past regarding the location etc. of the water heater.

For example, Patent Literature 1 proposes, for the purpose of preventing electrical components to which high voltage is applied from being damaged at the time of a front collision, to locate a water heater in the front compartment when both a water heater and a charger are fixed to a cross member, such that the front end of the water heater to which voltage is applied during driving is positioned rearwardly from the front end of the charger to which voltage is not applied during driving.

### PRIOR ART LITERATURE

### Patent Literature

[Patent Literature 1] JP2020-111136 A

### SUMMARY

### Problem to be Solved

By the way, the front compartment at the front part of a fuel cell vehicle is subject to low-temperature blowing air entering the vehicle through a grille opening at the front part of the vehicle and passing through a radiator or other heat exchanger.

Therefore, in a structure in which a water heater is located in the front compartment, the low-temperature running wind that enters the front compartment hits the water heater. This causes a problem that the amount of heat dissipated from the surface of the water heater increases. In particular, when the water heater is operated while the fuel cell vehicle is running at a high vehicle speed in winter, the large amount of heat dissipation from the surface of the water heater may cause a decrease in heating performance and a higher power consumption.

The present disclosure was made in view of these points, and it is an object of the present disclosure to provide a front structure of a fuel cell vehicle in which it is possible to suppress the blowing wind from hitting the water heater located in the front compartment of the vehicle.

### Solution for Solving Problem

In order to achieve the aforementioned purpose, the vehicle front structure of the present disclosure arranges a water heater in the front compartment in a low air velocity area where the blowing wind hardly acts on.

Specifically, the present disclosure relates to a vehicle front structure of a fuel cell vehicle equipped with a water heater to heat water for heating air for air-conditioning in a front compartment that is separated from a vehicle compartment by a dash panel.

The vehicle front structure is characterized in that the front compartment is provided with a front trunk that is partitioned from other spaces by a wall, and the water heater is located behind a rear wall portion of the front trunk.

By the way, in fuel cell vehicles, a battery pack is installed instead of an engine. And in many cases, the battery pack is installed on the floor of the vehicle body. Therefore, in the front compartment of the fuel cell vehicle, which corresponds to the engine compartment in an engine vehicle, the space where an engine used to be installed can now be used for other purposes. For this reason, recently there has been an increase in the number of cases where a trunk, which was previously located in the rear part of the vehicle, is now located in the front compartment.

In light of this, according to this configuration, the front trunk is separated from the other spaces in the front compartment by the wall, so that the front trunk functions as a wind shelter. This results in a low air velocity area in the area behind the front trunk, where the blowing wind hardly acts on.

In this way, since the water heater is located behind the rear wall portion of the front trunk, i.e. in the low air velocity area, the low-temperature blowing wind that enters the front compartment can be restrained from hitting the water heater. This makes it possible to suppress a large amount of heat dissipation from the surface of the water heater. Therefore, for example, when the fuel cell vehicle is driven at a high vehicle speed in winter, it is possible to suppress reduced heating performance and higher power consumption.

In the above vehicle front structure, the water heater may be arranged to be in contact with the rear wall portion of the front trunk.

According to this configuration, by arranging the water heater so that it is in contact with the rear wall portion of the front trunk that functions as a windbreak, the blowing wind is more difficult to hit the water heater. In addition, it is easier to secure installation space for other equipment, for example, compared to when the water heater is placed away from the rear wall portion. Thus, the degree of freedom of layout in the front compartment can be increased.

Furthermore, in the above vehicle front structure, the water heater may be connected via a bracket to a relatively rigid member in the front part of the vehicle.

According to this configuration, the water heater can be firmly supported by the relatively rigid member.

In the above vehicle front structure, the relatively rigid member may be a transaxle or a suspension tower housed within the front compartment.

According to this structure, the water heater can be supported by a simple structure by utilizing a member normally housed within the front compartment, such as a transaxle or a suspension tower.

### Effects of Present Disclosure

As explained above, according to the vehicle front structure of the present disclosure, it is possible to suppress the blowing wind from hitting the water heater located in the front compartment in a fuel cell vehicle.

### BRIEF DESCRIPTION OF DRAWINGS

FIG. 1 is a cross-sectional view schematically showing a front structure of a vehicle according to an embodiment of the present disclosure.

FIG. 2 is a plan view schematically showing the front structure of a vehicle.

FIG. 3 is a block diagram schematically showing an air conditioning system.

FIG. 4 is a cross-sectional view schematically showing the behavior of running wind.

### DESCRIPTION OF EMBODIMENTS

Hereinafter, a description of Embodiments is given based on the drawings.

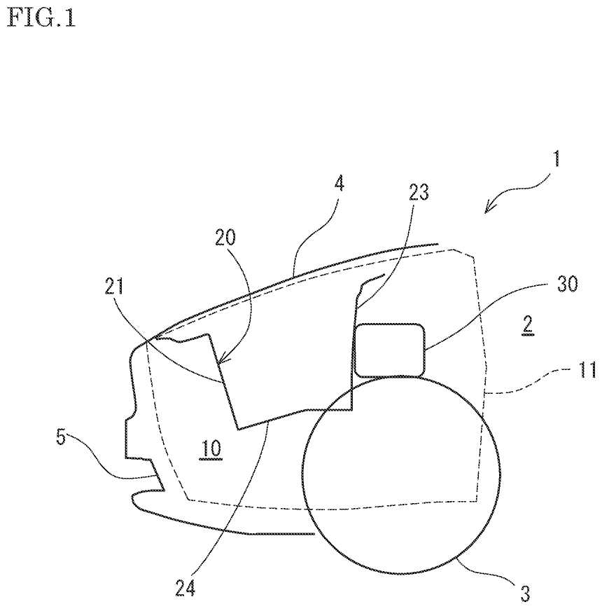

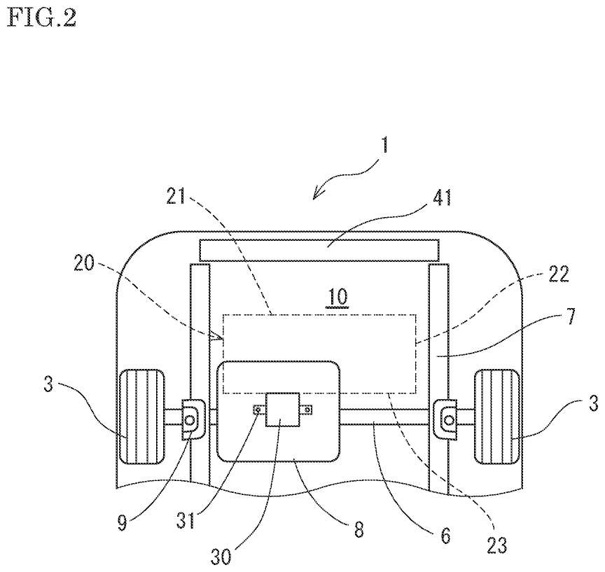

FIG. 1 is a cross-sectional view schematically showing a front structure of a vehicle according to an embodiment, and FIG. 2 is a plan view schematically showing the front structure of the vehicle. In FIG. 1, a front side member 7, a transaxle 8, a suspension tower 9, a radiator 41, etc. are omitted from the figure for ease of viewing.

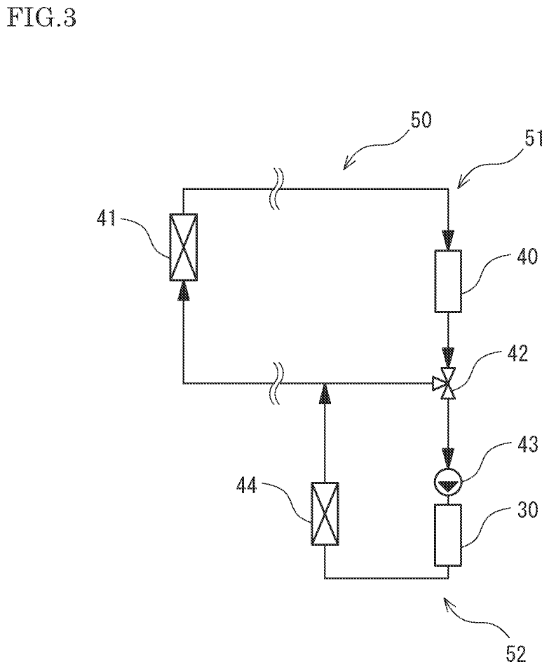

A vehicle 1 equipped with this vehicle front structure is configured as a fuel cell vehicle that runs using power generated by a fuel cell stack 40 (see FIG. 3). More precisely, the fuel cell vehicle 1 is equipped with the transaxle 8 that integrates a motor as a power source for driving and a reduction gearbox, as shown in FIG. 2. The driving force generated by a traveling motor rotationally driven by the electricity generated by the fuel cell stack 40 is output from the transaxle 8 after being decelerated by the reduction gearbox, and this driving force is transmitted to a left and right pair of front wheels 3, 3, via a drive shaft 6, so that the fuel cell vehicle 1 is driven.

A front end of the fuel cell vehicle 1 has a grille opening 5 for introducing low-temperature running air into the interior of the vehicle, which exchanges heat with the radiator 41.

The front structure of the vehicle has a front compartment 10, a front trunk 20, and a water heater 30, as shown in FIGS. 1 and 2.

The front compartment 10 is a space that is formed in front of a vehicle compartment 2 in which the occupants are seated, and that is located between the left and right pair of front wheels 3, 3. The front compartment 10 is the space enclosed by the dashed line in FIG. 1, and this space corresponds to an engine compartment in a conventional engine vehicle. As shown in FIG. 1, the front compartment 10 is separated from the vehicle compartment 2 at its rear end by a dash panel 11 and from the outside at its upper end by a hood 4. As shown in FIG. 2, a left and right pair of front side members 7, 7 extending in the front-rear direction of the vehicle delimits both ends of the front compartment 10 in the vehicle width direction. The transaxle 8 described above as well as the suspension towers 9 that are respectively coupled to the front side members 7 and that extend upwardly, are housed within this front compartment 10.

The front trunk 20 is a storage space, also referred to as a “frunk”, located under the hood 4. The front trunk 20 is housed within the front compartment 10. In the fuel cell vehicle 1, a battery pack (not shown) is installed in place of the engine. This battery pack is installed on the floor of the vehicle body. Therefore, the space that the engine used to occupy in the front compartment 10 corresponding to the engine compartment can be used as the front trunk 20.

As shown in FIGS. 1 and 2, the front trunk 20 is formed in an upwardly opening box shape and is provided with: a bottom wall portion 24 having a substantially rectangular shape in plan view; a front wall portion 21 extending upwardly from the front edge of the bottom wall portion 24; side wall portions 22, 22 extending upwardly from both side edges of the bottom wall portion 24, respectively; and a rear wall portion 23 extending upward from the rear edge of the bottom wall portion 24. The front trunk 20 is demarcated from other spaces in the front compartment 10 by these wall portions 21, 22, 23, and 24.

The water heater 30 is an electric high voltage heater (HVH: High Voltage Heater) that heats cooling water for heating air for air-conditioning, and is housed within the front compartment 10.

FIG. 3 is a block diagram schematically showing an air conditioning unit 50. The air conditioning unit 50 is provided in the fuel cell vehicle 1. As shown in FIG. 3, the air conditioning unit 50 has: a fuel cell cooling circuit 51 that mainly supplies cooling water to the fuel cell stack 40; and a heater circuit 52 that mainly supplies cooling water to the heater core 44. The air conditioning unit 50 controls the supply of the cooling water from the fuel cell cooling circuit 51 to the heater circuit 52. This allows the waste heat from the fuel cell stack 40 to be used for heating.

The fuel cell cooling circuit 51 has the fuel cell stack 40, the radiator 41, a radiator valve (not shown), and an air conditioning three-way valve 42.

The radiator valve is a solenoid valve. The radiator valve can switch the cooling water circulating through the fuel cell cooling circuit 51 to go through the radiator 41 or not to go through the radiator 41. The opening and closing of the radiator valve is controlled so that the cooling water flows through the radiator 41 when the water temperature at an inlet of the fuel cell stack 40 exceeds the target water temperature required to cool the fuel cell stack 40. As a result, the temperature of the cooling water is lowered at the radiator 41 through heat exchange with the low-temperature blowing air that enters the cabin through the grille opening 5. The cooling water thus lowered in temperature at the radiator 41 can cool the fuel cell stack 40, which is heated by power generation.

The air conditioning three-way valve 42 is a solenoid valve. The air conditioning three-way valve 42 can switch the cooling water discharged from the fuel cell stack 40 to go through the heater core 44 or not to go through the heater core 44. When the cabin temperature is high and heating is not required, the opening and closing of the air conditioning three-way valve 42 is controlled so that the cooling water circulates in the fuel cell cooling circuit 51, and when heating is required, the opening and closing of the air conditioning three-way valve 42 is controlled so that the cooling water also flows to the heater circuit 52 side.

The heater circuit 52, on the other hand, has the heater core 44 that provides heating by heat exchange with air, the water heater 30 that heats the cooling water supplied to the heater core 44, and a water pump 43 for circulating the cooling water in the heater circuit 52.

When the temperature of the cooling water is lower than the target water temperature at the inlet of the heater core 44, the output of the water heater 30 is controlled to heat the cooling water to a level where it can be used as a heat source for heating the interior of the vehicle. The cooling water heated by the water heater 30 flows through the heater core 44. The heater core 44 warms outdoor air introduced from outside the vehicle or internal air circulating inside the vehicle.

In the fuel cell vehicle 1, as described above, the running wind enters the vehicle interior through the grille opening 5 and passes through a heat exchanger such as the radiator 41. The low temperature running wind will then enter the front compartment 10.

Therefore, if the water heater 30 is simply placed inside the front compartment 10, the low-temperature running wind that enters the front compartment 10 will hit the water heater 30. Thereby, the amount of heat dissipated from the surface of the water heater 30 becomes large. In particular, when the water heater 30 is operated while the fuel cell vehicle 1 is driven at a high vehicle speed in winter, a large amount of heat dissipation from the surface of the water heater 30 is expected to result in reduced heating performance and higher power consumption.

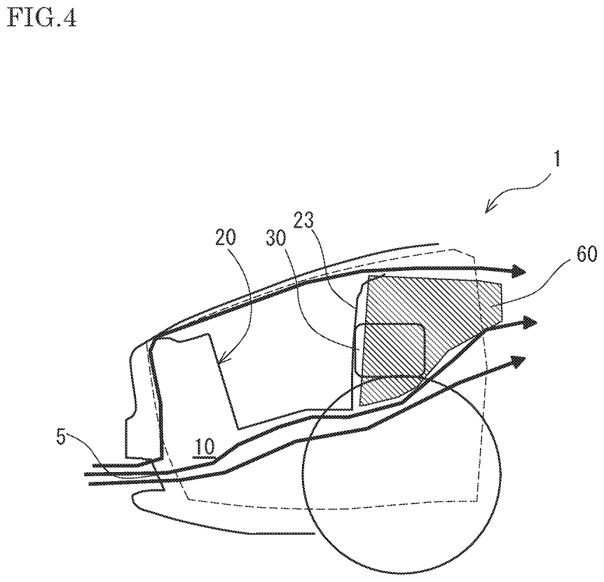

Therefore, in the vehicle front structure of this embodiment, the water heater 30 is placed in a low air velocity area 60 (see the hatched area in FIG. 4) in the front compartment 10.

Specifically, in the vehicle front structure of this embodiment, as shown in FIG. 1, the water heater 30 is disposed behind the rear wall portion 23 of the front trunk 20 within the front compartment 10, so as to be in contact with the rear wall portion 23. The water heater 30 is connected (e.g., bolted) to the transaxle 8 via a bracket 31. The water heater 30 is thus supported by the transaxle 8 (more precisely, the case of the transaxle 8), which is a relatively rigid member.

FIG. 4 is a cross-sectional view schematically showing the behavior of the running wind. The bold arrows in FIG. 4 each indicate the direction of the running wind.

The front trunk 20 is divided from other spaces in the front compartment 10 by the wall portions 21, 22, 23, and 24 as described above. The front trunk 20 thus functions as a wind shelter, as shown in FIG. 4. This results in the low air velocity area 60 in the area behind the front trunk 20, where the blowing wind hardly acts on, as shown by the hatched area in FIG. 4.

Thus, in the front structure of the vehicle of this embodiment, the water heater 30 is placed behind the rear wall portion 23 of the front trunk 20, in other words, in the low air velocity area 60. This prevents low-temperature blowing air entering the front compartment 10 from hitting the water heater 30. This makes it possible to suppress a large amount of heat dissipation from the surface of the water heater 30. Thus, for example, when the fuel cell vehicle 1 is driven at a high vehicle speed in winter, it is possible to suppress a decrease in heating performance and a high power consumption.

Moreover, by arranging the water heater 30 so that it is in contact with the rear wall portion 23 of the front trunk 20 that functions as a wind shelter, the blowing wind is even more difficult to hit the water heater 30.

Also, by arranging the water heater 30 so that it is in contact with the rear wall portion 23, it is easier to secure space for other equipment, for example, compared to when the water heater 30 is arranged away from the rear wall portion 23. Thus, the degree of freedom of layout within the front compartment 10 can be increased.

Furthermore, the water heater 30 is connected to the transaxle 8 that is a relatively rigid member in the front part of the vehicle, via the bracket 31. Thus, the water heater 30 can be firmly supported. In addition, by utilizing a member such as the transaxle 8, which is normally present in the front compartment 10, the water heater 30 can be supported with a simple structure.

### Other Embodiments

The present disclosure is not limited to the foregoing embodiments and can be implemented in various other forms without departing from its spirit or main features.

In the above embodiment, the water heater 30 is arranged to be in contact with the rear wall portion 23 of the front trunk 20, but it is not limited thereto, provided that the water heater 30 is within the low air velocity area 60. The water heater 30 may be positioned away from the rear wall portion 23 of the front trunk 20.

In the above embodiment, the water heater 30 is supported by the transaxle 8, but it is not limited thereto, provided that the water heater 30 is supported by a relatively rigid member in the front part of the vehicle. For example, the water heater 30 may be supported by the suspension tower 9.

Furthermore, in the above embodiment, the present disclosure is applied to the so-called front engine front drive fuel cell vehicle 1, but it is not limited thereto. For example, the present disclosure may be applied to a front engine rear drive fuel cell vehicle.

Thus, the embodiments described above are in all respects merely illustrative and should not be construed as limiting. Furthermore, all variations and modifications that fall within the meaning and range of equivalency of the claims are to be embraced therein.

### INDUSTRIAL APPLICABILITY

According to the present disclosure, it is possible to suppress the running wind from hitting the water heater located in the front compartment. This makes it extremely beneficial when applied to vehicle front structures equipped with a water heater in the front compartment.

What is claimed is:

1. A vehicle front structure of a fuel cell vehicle comprising a water heater in a front compartment partitioned from a vehicle compartment by a dash panel, the water heater heating water for heating air for air-conditioning, wherein
a front trunk is provided in the front compartment partitioned from other spaces by a wall, and
the water heater is located on a rear side of a rear wall portion of the front trunk.

2. The vehicle front structure according to claim 1, wherein
the water heater is arranged to be in contact with the rear wall portion of the front trunk.

3. The vehicle front structure according to claim 1, wherein
the water heater is connected, via a bracket, to a relatively rigid member in a front part of the vehicle.

4. The vehicle front structure according to claim 3, wherein
the relatively rigid member is a transaxle or a suspension tower housed within the front compartment.
